(19) United States
(12) Patent Application Publication
(10) Pub. No.: US 2020/0107564 A1
(43) Pub. Date: Apr. 9, 2020

(54) MIX FOR FOODSTUFF, FOODSTUFF, METHOD AND USE

(71) Applicants: Luca BARBIERI, BRESCIA (IT); Alessandro MACCA, BRESCIA (IT); Fabrizio MURATORI, VARESE (IT); Federico VIGNATI, MILANO (IT); Gianleone DI SACCO, MILANO (IT)

(72) Inventors: Luca BARBIERI, BRESCIA (IT); Alessandro MACCA, BRESCIA (IT); Fabrizio MURATORI, VARESE (IT); Federico VIGNATI, MILANO (IT); Gianleone DI SACCO, MILANO (IT)

(21) Appl. No.: 16/496,757

(22) PCT Filed: Mar. 23, 2018
(86) PCT No.: PCT/IB2018/051983

§ 371 Date: Sep. 23, 2019

(30) Foreign Application Priority Data
Mar. 24, 2017 (IT) 102017000032767

(51) Int. Cl. A23L 7/109; A21D 2/24; A23L 33/21; A21D 13/066; A23L 7/10

(52) U.S. Cl. CPC A23L 7/109; A21D 2/245; A23L 7/101; A21D 13/066; A23L 33/21

(57) ABSTRACT

A mix is suitable for the production of a gastronomic compound foodstuff, comprising a cereal flour and at least one essential amino acid. A method of preparing the mixture involves the use of a mixture of isolated essential amino acids added to a cereal flour.

The present invention relates to an edible mix. Furthermore, it is an object of the present invention a method for making such a mix and the relative gastronomic foodstuffs obtainable through such a mix; in particular, pasta or bakery products, such as pasta, bread, pizza, biscuits and the like.

It is known that from an age of about 45 years, there is a progressive and physiological decrease in muscle mass due to a natural reduction in muscle protein synthesis and/or to a loss and disorganization of myofilaments. In some cases, the consequences of this loss are so important as to constitute a real pathology known as sarcopenia, responsible for the main causes of weakness and disability in the elderly.

To compensate for this loss, over the years protein or high protein diets have been developed to try to counter this deficiency. However, proteins have the disadvantage of determining an increased nitrogen load for the kidney, with the consequent risk of compromising kidney function, especially in the elderly person.

A possible alternative to the administration of high-protein diets is represented by the oral administration of amino acids, which are the constitutive units of proteins.

To date, in an inappropriate manner, the intake of amino acids occurs in a medicalized manner, that is, by means of sachets whose content is administered orally. Given the strongly bitter taste of amino acids, the content of the sachets is also strongly sweetened, thus limiting the intake in particular types of subjects.

Disadvantageously, the medicalized intake of the amino acids does not allow an effective control on the doses assumed by a subject, above all in relation to the type of daily diet followed by the subject.

One of the aims of the present invention is to obviate a medicalized intake of the amino acids, so as to overcome the drawbacks mentioned above and in such a way as to make the assumption of such amino acids easier and more effective.

This object is achieved by a mix, by a method of making the mixture, by a foodstuff and by use according to the appended independent claims. The dependent claims describe embodiment variations.

The features and the advantages of present invention will appear more clearly from the following description, made by way of an indicative and non-limiting example with reference to the accompanying figures, in which:

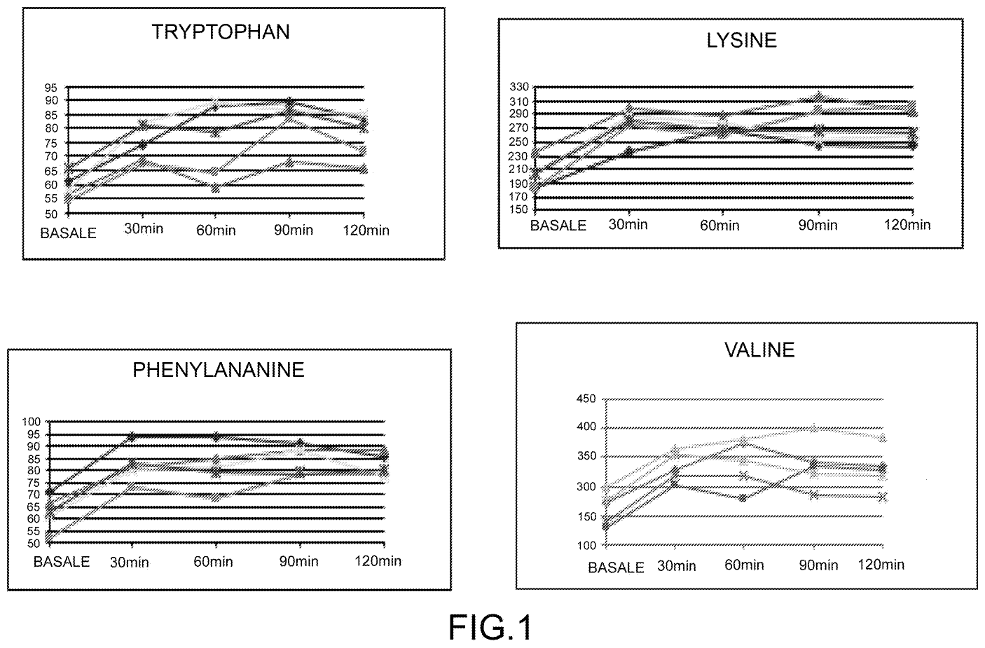

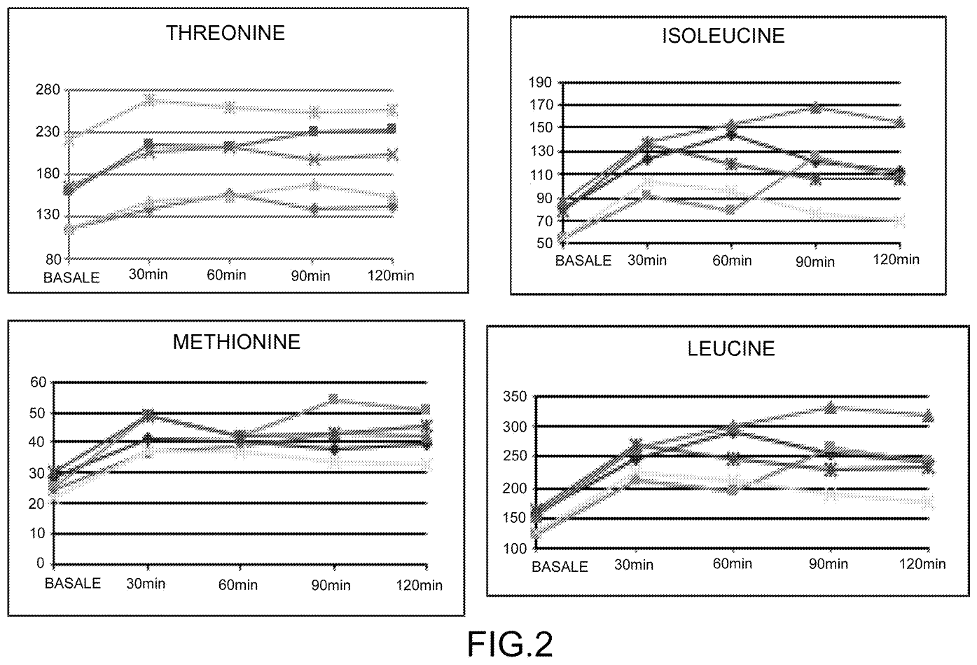

FIG. 1 and FIG. 2 show the bioavailability graphs for each essential amino acid included in an embodiment of a mix according to the present invention;

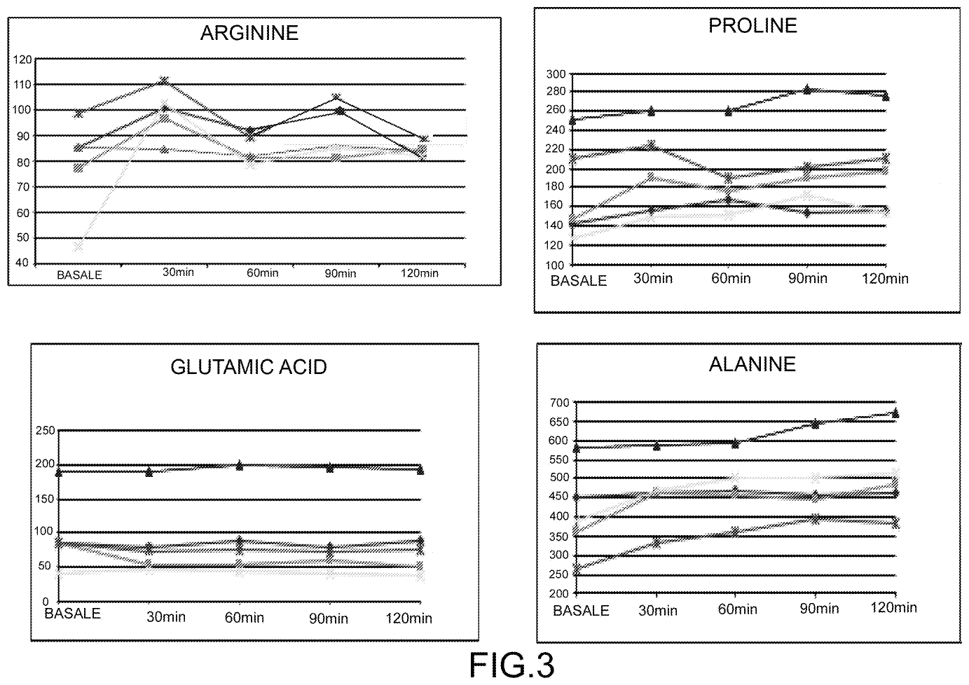

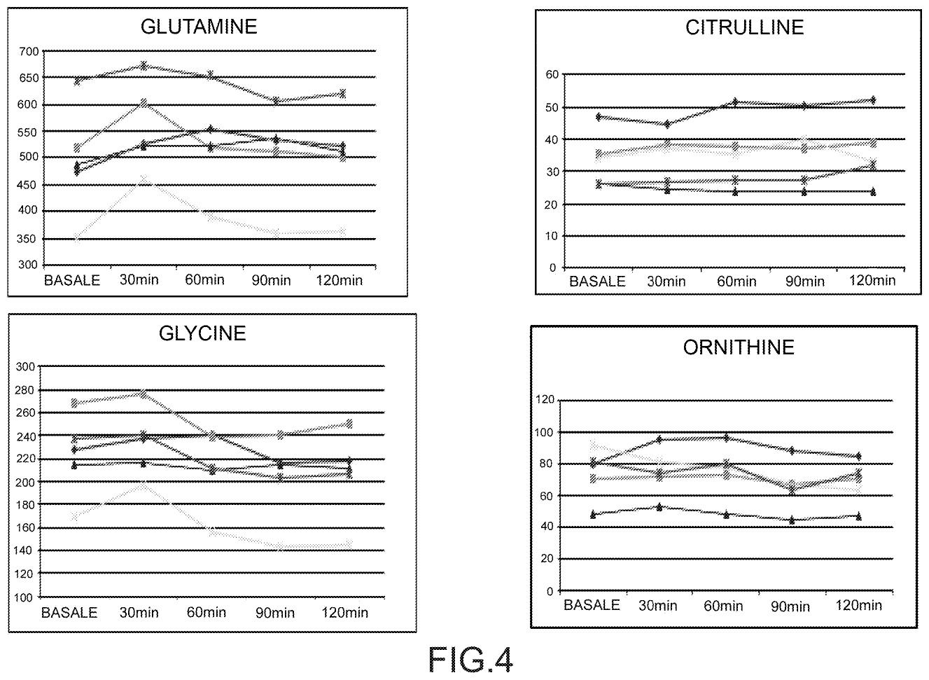

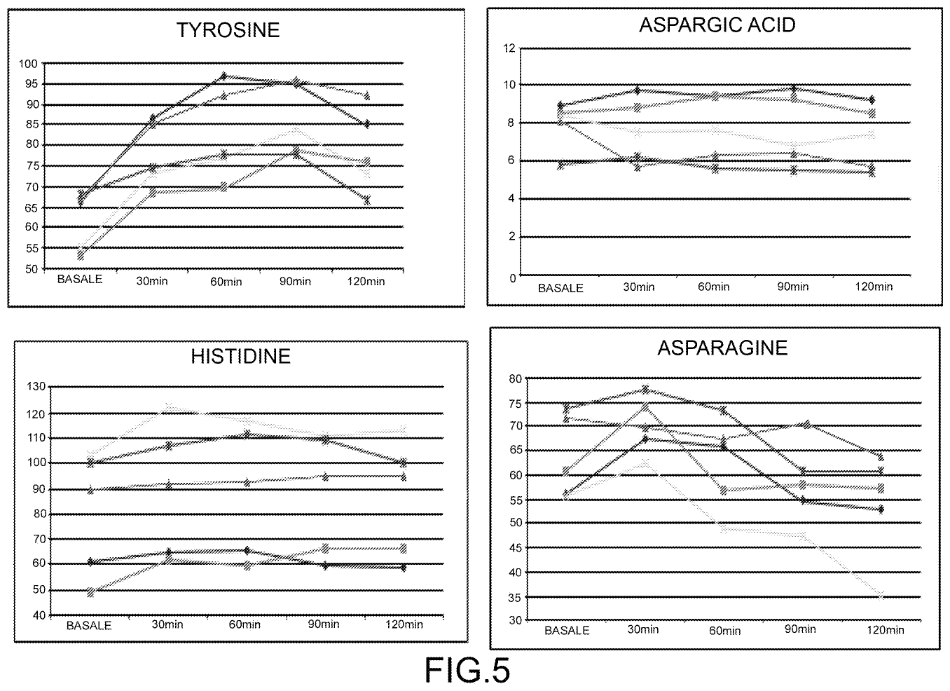

FIGS. 3, 4 and 5 show the bioavailability graphs for each non-essential amino acid included in a mix in the same embodiment of the mix whose bioavailability graphs for the essential amino acids are shown in FIGS. 1 and 2.

The mix according to the present invention is particularly suitable for the production of a gastronomic compound foodstuff, for example a pasta product or a bakery product, such as, among others, pasta, ravioli, gnocchi, bread, pizza, focaccia, cookies and the like. The mix comprises a cereal flour, with or without gluten, and one or more (i.e. a mix) of the essential amino acids, preferably one or more of the essential amino acids selected from the group comprising L-leucine, L-lysine, L-isoleucine, L-valine, L-threonine, L-cysteine, L-histidine, L-phenylalanine, L-methionine, L-tyrosine, L-tryptophan.

In other words, the essential amino acid is added to the cereal flour. For example, the essential amino acid is added in its isolated form (e.g. in the form of zwitterion), preferably in the form of an aqueous solution or in the form of crystalline powder or the like.

Therefore, another object of the present invention

is the use of an isolated amino acid or a mixture of isolated amino acids, preferably a mixture of isolated essential amino acids, for preparing a mixture to make a foodstuff product.

Therefore, it is contemplated to use the isolated amino acid or the mixture of isolated amino acids to add them to the cereal flour, with the aim of obtaining a mix thereof.

The word “cereal” is to be understood in the broadest sense of the word. For example, any plant or plant product whose fruit or starch-rich seeds are used by man for obtaining starchy products, such as polenta, soups, bread, pasta to be cooked, and the like, is to be understood as a cereal. Therefore, corn, rice, wheat (soft wheat, durum wheat, spelt, etc.), barley, sorghum, millet, oats, triticale, rye, buckwheat, fonio, quinoa and the like are to be considered cereals.

Preferably, the mix also comprises thiamine and/or pyridoxine.

In addition, preferably, the mix comprises at least one of the essential amino acids selected from the group comprising L-leucine, L-lysine, L-isoleucine, L-valine, L-histidine, L-phenylalanine, L-methionine, L-tyrosine, L-tryptophan and at least one essential or conditionally essential amino acid selected from the group comprising: arginine, citrulline, ornithine, cysteine, glutamine, glycine, serine, proline, taurine and tyrosine.

In an embodiment variant, the mix comprises at least one of the essential amino acids, preferably selected from the group comprising L-leucine, L-lysine, L-isoleucine, L-valine, L-histidine, L-phenylalanine, L-methionine, L-tyrosine, L-tryptophan, L-threonine and at least one non-essential amino acid, preferably a non-essential amino acid selected from the group comprising: alanine, aspartic acid, asparagine, glutamic acid.

Preferably, the mix comprises both a conditionally essential amino acid and a non-essential amino acid, for example selected from the groups indicated in the preceding paragraphs.

In other words, one or more non-essential or conditionally essential amino acids are additionally added to the cereal flours.

In a non-limiting way, in addition to the flour and at least one of the essential amino acids, the mix may comprise ingredients suitable to give a particular mechanical and organoleptic consistency for the correct achievement of a desired final foodstuff (for example, water, salts, any yeasts, eggs and the like).

According to advantageous variants of the mix, the amino acid content (intended as the total amount of all the amino acids present) is equal to at least 4% or, even more preferably, to at least 8% by weight, with respect to the total weight of the mix.

Preferably, the content of the essential amino acids is equal to at least 4% or, even more preferably, to at least 8% by weight, with respect to the total weight of the mix.

In a particularly advantageous variant of the mix, the amino acid content (intended as the total amount of all the amino acids present) is less than or equal to 15 g per 100 g of final product. In other words, the percentage by weight of amino acids is less than or equal to 15% with respect to the total weight of the mix. Such a content of amino acids allows to obtain a mix with an adequate compromise between nutritional effects (both therapeutic and preventive) and organoleptic effects linked to taste (mainly to the non-perception of the bitter taste of the amino acids).

In the remainder of the present description, where ranges of values are indicated (e.g., percentages by weight), the extremes of these ranges are to be considered included.

In particular, an embodiment variant of the mix having an amino acid content of between 7% and 9% by weight (preferably 8% by weight) with respect to the total weight of the dough proved to be particularly effective.

Preferably, the content of each of the amino acids L-threonine, L-cysteine, L-histidine, L-phenylalanine, L-methionine, L-tyrosine, L-tryptophan is between 0.1% and 15% by weight with respect to the total weight of the mix. If there is a mixture of two or more of the amino acids L-threonine, L-cysteine, L-histidine, L-phenylalanine, L-methionine, L-tyrosine, L-tryptophan, the percentage by weight of this mixture is between 0.1% and 15% and is intended as the total sum of the percentages by weight of each of the aforesaid amino acids that make up the mixture.

In an advantageous embodiment, if there is a mixture of two or more of the essential amino acids, the percentage by weight of at least one of the essential amino acids is between 17% and 23% by weight with respect to the total weight of the mixture of the essential amino acids. In particular, preferably, the percentage by weight of leucine in the amino acid mixture is between 20% and 22% by weight with respect to the total weight of the mixture of the essential amino acids.

In a preferred embodiment, the mix comprises a mixture of all the essential amino acids L-leucine, L-lysine, L-isoleucine, L-valine, L-threonine, L-histidine, L-phenylalanine, L-methionine, L-tyrosine, L-tryptophan (hereinafter referred to as Mixture A). Such a mix a may also include L-cysteine.

In this variant (Mixture A), preferably, the percentage by weight of the mixture of amino acids is between 5% and 15%, to obtain a product with a high biological value.

In a further embodiment of the mixture, in addition to the essential amino acids, the amino acid mixture comprises at least one conditionally essential or non-essential amino acid, preferably a conditionally essential or non-essential amino acid selected from the group comprising arginine, citrulline, ornithine, cysteine, glutamine, glycine, serine, proline, taurine, tyrosine, alanine, aspartic acid, asparagine, glutamic acid, threonine. This allows to obtain a nutritional versatility of the mixture where, due to the lack of synthesis, there is a need for other amino acids besides the essential ones. Preferably, in this embodiment, the mix comprises a mixture of all the following amino acids: cysteine, alanine, arginine, aspartic acid, glutamine, glycine, proline and serine (hereinafter Mixture B).

Preferably, the content of each of the amino acids of the group comprising cysteine, alanine, arginine, aspartic acid, glutamine, glycine, proline, serine is between 0.1% and 15% by weight with respect to the total weight of the mix. If there is a mixture of two or more non-essential amino acids, or preferably a mixture of two or more amino acids selected from the group comprising cysteine, alanine, arginine, aspartic acid, glutamine, glycine, proline, serine, the percentage by weight between 0.1% and 15% is to be understood as a total sum of the percentages by weight of each of the aforesaid amino acids that make up the mixture, so as to ensure therapeutic efficacy and gustatory pleasantness.

The mix made according to the present invention preferably also includes one or more of the following components: wheat flour, dietary and/or wheat fiber, eggs, butter, granulated sugar, fructose and erythritol mixture, agave syrup, honey, sweeteners, maltitol, glucose syrup, malt extract, oil of various seeds, olive oil, extra virgin olive oil, palm oil, vanilla, dark chocolate, leavening agents.

The aforesaid components are suitably mixed together with the amino acids according to the final gastronomic product (foodstuff) to be produced.

In one embodiment, the mix comprises medium-chain triglycerides. For example, medium-chain triglycerides are added to the mixture of cereal flour and at least one of the essential amino acids. In this way a particularly useful synergic effect is obtained due to the intake of a food comprising essential amino acids also in subjects suffering from hyposecretory pancreatitis.

The method of preparation of the mix for the production of a gastronomic compound foodstuff comprises the step of preparing a dry mixture of essential amino acids with dietary and/or wheat fibers.

In a particularly advantageous variant, the mix comprises dietary fibers, for example dietary fibers with and without gluten, in a percentage between 2% and 20% by weight with respect to the total weight of the mix, even more preferably between 4% and 15% by weight.

Moreover, preferably, the mix comprises food flavors, for example one or more of the following flavors: butter, vanilla, cocoa, citrus fruit, fruit in general, in an amount between 1 gr and 15 gr per kilogram of the final mix, even more preferably between 3 gr and 9 gr per kilogram of the final mix.

The above percentages of dietary fibers together with the percentages of amino acids indicated above, and preferably also the percentages of natural flavors mentioned above, allow the incorporation of the amino acids in the mix and at least partially to more effectively neutralize the bitter taste of the amino acids.

The method for producing the gastronomic compound foodstuff comprises a cooking step, in which the cooking temperature is between 145° and 190°, preferably between 150° and 240°, and even more preferably it is equal to 180°, preferably for 20-30 minutes in relation to the mix volumes and the thickness of the food before cooking.

Below are some recipes and some procedures for making mix variants according to the present invention intended to obtain corresponding foodstuff products.

### Example 1

A first example of embodiment provides a mix for preparing cookies or sweet baked products. This type of mixture provides a mix comprising any mixture of amino acids described in the preceding paragraphs (for example, Mixture A, which includes only essential amino acids, or Mixture B, which includes essential amino acids and non-essential amino acids, or a combination of mixture A and B) to which to add one or more of the components selected from the following list: flour (of wheat type “0” or “00”, or whole or half-whole), dietary and/or wheat fibers, chicken eggs, butter, granulated sugar, mixture of fructose and erythritol, agave syrup, honey, sweeteners, maltitol, glucose syrup, malt extract, various seed oil, olive oil, extra virgin olive oil, palm oil, vanilla, nuggets of dark chocolate, leavening agents.

A method of preparing the mix to obtain cookies or sweet baked goods includes the following steps:

a) working the hen eggs in a kneader

with sugar and a mixture of amino acids according to the present invention;

b) adding an oil or fat selected from the list of components previously listed, and preferably plastic butter at a temperature between 8 and 21° C.;

c) adding flour and dietary fiber at the same time;

d) adding flavoring and leavening agents;

e) mixing the mix to obtain a smooth, compact and homogeneous mix.

Subsequently, it is possible to provide a step of refrigeration of the mix in vacuum bags.

Finally, for making cookies and/or desserts, once the forming or casting has been carried out, the baking in the oven takes place in a temperature range of between 180 and 240° C. according to the mix volumes and the cookie size.

### Example 2

A second embodiment example provides a mix intended for the preparation of bread, focaccia, pizza, loaf bread, pan focaccia, piadina, rusks. This type of mix provides a mix comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: flour (of wheat type “0” or “00”, or whole or half-whole), fresh or starter or chemical yeast, dietary and/o wheat fiber, iodised sea salt, aromatic herbs, fats and edible oils releasing essential oils of aromatic herbs, natural water (minimally mineralized, or oligomineral, mineral, medium mineral or hypermineral).

Preferably, by aromatic herbs it is meat one or more of the following aromatic herbs: bay leaf, dill, basil, caper, chervil, chives, privet, marjoram, lemon balm, mint, oregano, chili pepper, parsley, rosemary, sage, savory, shallot.

A method of preparation of the mix to obtain bread, focaccia, pizza, loaf bread, pan focaccia, piadina, rusks includes the following steps:

a2) mixing dietary fiber (e.g. any edible, soluble or insoluble dietary fiber) and a mixture of amino acids according to the present invention;

b2) combining the mixture obtained in step a2) with a selected flour;

c2) adding yeast, water, salt and extra virgin olive oil.

### Example 3

A third example of embodiment provides a mixture intended for the preparation of crepes. This type of mix provides a mix comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: flour (of wheat type “0” or “00”, or whole or half-whole), cow's milk, goat's milk, sheep, rice or soy milk, chicken eggs, iodised sea salt, extra virgin olive oil, natural water (minimally mineralized, or mineral, mineral, medium mineral or hypermineral).

A method of preparing the mix to obtain crepes includes the following steps:

a3) whisking eggs, milk, a mixture of amino acids according to the present invention, natural water, dietary fibers, flour or semolina.

### Example 4

A fourth example of embodiment provides a mix for the preparation of fresh and/or extruded pasta. This type of mix provides a mix comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: flour (of wheat type “0” or “00”, or whole or half-whole), durum wheat semolina, dietary and/or wheat fiber, hen's eggs, natural water (minimally mineralized, or oligomineral, mineral, average mineral or hypermineral).

A method of preparing the mix to obtain fresh, and/or extruded, and/or laminated pasta includes the following steps:

a4) whisking eggs, a mixture of amino acids according to the present invention, water, dietary fibers, flour or semolina.

### Example 5

A fifth example of embodiment provides a mix for the preparation of potato and/or semolina gnocchi. This type of mix provides a mix comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: flour (of wheat type “0” or “00”, or whole or half-whole), semolina flour, potatoes, other flours, white or vitelotte potatoes, or in a mixed way, durum wheat semolina, dietary and/or wheat fibers, hen's eggs, iodised sea salt, spices and/or aromatic herbs, natural water (minimally mineralized, or oligomineral, average mineral or hypermineral).

A method of preparing the mix to obtain potato and/or semolina gnocchi includes the following steps:

a5) adding to the base of potatoes and/or semolina, vegetable fiber mixed with a mixture of amino acids according to the present invention;

b5) adding salt, eggs, spices and water, dietary fiber, flour (in the case of potato gnocchi).

### Example 6

A sixth embodiment provides a versatile mix, which can be used for making or replacing certain foods. This type of mix provides a mix comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: dietary and/or wheat fiber, aromatic herbs and spices.

Preferably, the spices are selected from the group comprising anise, coriander, cumin, wild fennel, juniper, pepper, mustard, thyme, saffron.

A method of preparation of the versatile mix includes the following steps:

a6) dry-mixing a mixture of amino acids according to the present invention, the dietary and/or wheat fibers and the aromatic herbs and/or spices.

The versatile mix can be used to replace eggs or starches in making stuffing, or for making egg-based recipes like omelettes, soufflés and pies. Further, the versatile mix can be used to enrich sauces and condiments such as meat sauce, bechamel, or sauces or for the preparation of cannelloni, lasagna, pastries and rice timbales.

In addition, preferably, the versatile mix can be mixed with vegetable creams, minestrone, passed in such a way as to “bind” the aforementioned preparations avoiding starches and fatty substances and to simultaneously improve their nutritional value.

Further examples and methods for making mixes according to the present invention are detailed below, with particular reference to mixes suitable for producing gluten-free and/or lactose-free foods.

### Example 7

A seventh example of embodiment provides a mix for the preparation of cookies or sweet baked products without gluten and/or lactose. This type of mix provides a mixture comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: rice flour, corn starch, rice starch, tapioca starch, tapioca, potato starch, pea powder (flour), teff flour, quinoa flour, soy flour, buckwheat flour, naturally gluten-free dietary fibers, thickeners and stabilizers permitted, hen's eggs, butter or non-hydrogenated margarine for lactose intolerance, granulated sugar, fructose mixture and erythritol, agave syrup, honey, erythritol, sweeteners, maltitol, glucose syrup, various seed oil, olive oil, extra virgin olive oil, vanilla, nuggets dark chocolate, leavening agents.

A method of preparing the mix to obtain cookies or sweet baked goods without gluten and/or lactose includes the following steps:

a7) working hen eggs in a kneader with sugar and a mixture of amino acids according to the present invention;

b7) adding butter or fat selected from the list of components previously listed, and preferably plastic butter at a temperature preferably of between 15 and 18° C.;

c7) simultaneously adding flour and/or a starch and dietary fiber, gluten-free;

d7) adding flavoring and leavening agents;

e7) mixing the mix to obtain a smooth, compact and homogeneous mix.

Subsequently, it is possible to provide a step of refrigeration of the mix in vacuum bags.

Finally, for making cookies and/or desserts, once the forming or casting has been carried out, the baking in the oven takes place in a temperature range of between 180 and 240° C. according to the mix volume and size.

### Example 8

An eighth embodiment example provides a mix intended for the preparation of bread, focaccia, pizza, loaf bread, pan focaccia, piadina, biscuits without gluten and/or lactose. This type of mix provides a mixture comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: rice flour, corn starch, rice starch, tapioca starch, tapioca, potato starch, pea powder (flour), teff flour, quinoa flour, soy flour, buckwheat flour, naturally gluten-free dietary fibers, thickeners and stabilizers permitted, fresh or starter yeast, iodised sea salt, aromatic herbs and/or spices, olive oil releasing essential oils of aromatic herbs, extra virgin olive oil releasing essential oils of aromatic herbs, natural water (minimally mineralized, or oligomineral, average mineral or hypermineral).

A method of preparation of the mix to obtain bread, focaccia, pizza, loaf bread, focaccia bread, piadina, gluten-free and/or lactose-free cookies includes the following steps:

a8) mixing gluten-free dietary fiber and a mixture of amino acids according to the present invention;

b8) combining the mixture obtained in step a8) with a flour and/or starch selected from the previous list;

c8) adding yeast (in one of the types of yeast: dry, compressed, fresh, beer, chemical or starter yeast), water, salt and extra virgin olive oil.

### Example 9

A ninth example of embodiment provides a mix for the preparation of gluten-free and/or lactose-free crepes. This type of mix provides a mixture comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: rice flour, corn starch, rice starch, tapioca starch, tapioca, potato starch, pea powder (flour), teff flour, quinoa flour, soy flour, buckwheat flour, naturally gluten-free dietary fibers, fresh or starter or chemical yeast, cow's milk, goat's milk, sheep's, woman's milk, rice or soybeans, hen's eggs, iodised sea salt, extra virgin olive oil, natural water (minimally mineralized, or oligomineral, average mineral or hypermineral).

A method of preparing the mix to obtain gluten-free and/or lactose-free crepes includes the following steps:

a9) whisking eggs, milk, a mixture of amino acids according to the present invention, natural water, gluten-free food fibers, flour selected from the previous list of ingredients.

### Example 10

A tenth example of embodiment provides a mix for the preparation of pasta, fresh and/or extruded gluten-free and/or lactose-free. This type of mix provides a mixture comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: rice flour, corn starch, rice starch, tapioca starch, tapioca, potato starch, pea powder (flour), teff flour, quinoa flour, soy flour, buckwheat flour, naturally gluten-free dietary fibers, permitted thickeners and stabilizers, natural water (minimally mineralized, or oligomineral, average mineral or hypermineral).

A method of preparation of the mix to obtain gluten-free and/or lactose-free pasta, fresh and/or extruded comprises the following steps:

a10) whisking eggs, a mixture of amino acids according to the present invention, water, naturally gluten-free food fibers, flour selected from the previous list of ingredients.

### Example 11

An eleventh example of embodiment provides a mix for the preparation of potato gnocchi without gluten and/or lactose. This type of mix provides a mixture comprising any mixture of amino acids as described so far (for example, Mixture A, which includes only essential amino acids, or Mixture B, which includes essential amino acids and non-essential amino acids, or a combination of mixture A and B) to which one or more of the components selected from the following list are added: white or vitelotte potatoes, potato flour, other flours, or other gluten-free flour, rice flour, cornstarch, rice starch, tapioca starch, tapioca, potato starch, pea flour (flour), teff flour, quinoa flour, soy flour, buckwheat flour, naturally gluten-free dietary fiber, chicken eggs, iodised sea salt, spices and/or aromatic herbs, natural water (minimally mineralized, or oligomineral, average mineral or hypermineral).

A method of preparing the mix to obtain gluten-free and/or lactose-free potato gnocchi includes the following steps:

a11) combining with the potato base, a naturally gluten-free dietary fiber mixed with a mixture of amino acids according to the present invention;

b11) adding salt, eggs, spices and water, a flour selected from the previous list of ingredients.

### Example 12

A further example of embodiment provides for the realization of a cookie. In this embodiment, the production method involves foaming the egg component using only 50% of the amount of sugar provided for the total mixture, performing this procedure in a bain-marie with a temperature strictly maintained between 50 and 55° C.; the foaming and adjustment times of the mixture at the pre-set temperature induce modifications in the protein components able to better amalgamate, protect and stabilize the amino acid component with the remaining ingredients, favoring a better and more uniform gilding of the product.

Moreover, in a preferred embodiment of the invention for the production of bakery products (cakes, biscuits of various kinds, bi-toasted), it is contemplated to mix protein components derived from eggs, with percentage variations related and secondary to the quantity of amino acids, at the density and softness of the mix, for example with a process similar to that indicated in example 12 for the preparation of the cookie.

### Example 13

In the case of bakery products, it was necessary to change the ingredients and techniques. In fact this type of products provides aggregations of ingredients (with the exception of very rare cases) of butter and eggs. In this embodiment, the mix includes dietary fiber with or without gluten, including flours obtained from legumes. In the case of addition of extra virgin olive oil, the method preferably provides for subjecting the oil to vacuum techniques, possibly and preferably with the addition of aromatic herbs or with the addition of spices treated with the technique of vaporization and abatement.

This procedure determines a reduction of unpleasant flavors and of the amino acid aftertaste. The techniques described above contribute to the elimination of unpleasant flavors, even without the need for use of aromas in the mixture.

Preferably, moreover, for the realization of the gastronomic compound food, the method comprises a cooking step, in which the cooking temperature is between 145° and 190°, or between 150° and 240°, for 20-30 minutes in relation to the volumes of mix and the thickness of the food before cooking.

Innovatively, the present invention relates to a mix which allows to introduce the intake of essential amino acids in the daily food routine of an individual, for example in the form of pastes, breads, focaccia or bakery products. This favors the intake of amino acids in a prolonged time consistent with the expected effect of protection of muscle masses both in the elderly and in the subject subjected to metabolic stress (or in any case physiological or paraphysiological situations with a high need for amino acids). The administration of amino acids in chronic, in the form of foods that are pleasing in terms of taste and gastronomy (and, in fact, not distinguishable as flavor and aroma from common foods without added amino acids), it is a novelty in a world food panorama dominated by high-protein foods, which have the disadvantages already listed. The direct intake of amino acids allows the desired effects of food protection and supplementation to be achieved more quickly and more safely and effectively.

Therefore, the administration of amino acids not through “medicalized” products (tablets, sachets, solutions, etc.), but with common food products for daily use, allows the chronic administration of an adequate amount of amino acid aimed at preserving the muscle mass of large sections of the population with increased needs (from the elderly, to the growing subjects, to athletes, or subjects that for various diseases must counter the predictable loss of lean mass due to sarcopenia-causing and/or cachetizing diseases).

Furthermore, the fortification of foodstuffs of common and daily use with essential and non-essential or conditionally essential amino acids, is an element of undoubted advantage for the nutrition of the population in endemically poor countries in the feeding of animal proteins.

One embodiment of the mix which involves the use of an amino acid mixture comprising 23 amino acids, between essential and non-essential amino acids (or non-essential conditional), selected and assembled in consideration of their bioactive and nutritional characteristics has proved particularly effective.

In this advantageous embodiment example, the mix according to the present invention has been used for cooking a biscuit, subsequently administered to a sample of selected subjects. An experimentation was then carried out aimed at demonstrating the full bioavailability of the amino acids contained in the biscuit, with a final product characterized by excellent palatability (absence of the bitter taste characteristic of the amino acid mixture, fragrance, softness, easy chewiness, etc.). In this specific embodiment, the mix contained a mixture of essential amino acids, present in a ratio of 8 g/100 g of final product. In particular, the mix comprised L-Leucine, L-Isoleucine, L-Valine, L-Lysine, L-Threonine, L-Histidine, L-Phenylalanine, L-Methionine, L-Tryptophan, Cysteine, Arginine, Citrulline, Ornithine, Glutamine, Glycine, Serine, Proline, Tyrosine, Taurine, Alanine, Asparagine, Aspartic acid, Glutamic acid. Ten healthy subjects, divided into two groups, of the same number, 5 aged over 60, and 5 under the age of 40, took on the day of the test, n. 4 biscuits of 25 gr/each, while simultaneously drinking 500 ml of mineral water, at the initial time, and after having performed a basal sampling for the dosage of blood sugar, insulinemia and blood amino acids, followed by another four samples after 30 minutes, after 60 minutes, 90 minutes and 120 minutes. An aminoacidogram was then performed on each sample.

On each sample over the initial time, it was found, since the first 30-minute sample, the blood increase in the values of the administered amino acids, elevation persisting for all the other times, up to the end of the curve (minute 120).

The graphs shown in FIGS. 1 to 5 show, for each single amino acid included in the mix of the administered biscuit, the relative blood elevation and bioavailability in the times described by the single curves, between 30 and 120 minutes.

In particular, the essential amino acids (L-Leucine, L-Isoleucine, L-Valine, L-Lysine, L-threonine, L-Histidine, L-phenylalanine, L-Methionine, L-Tryptophan) show a homogeneous growth at 30° and 60 minutes after administration, subsequently maintaining a blood level above baseline levels for almost the entire curve.

With regard to non-essential amino acids, a rapid increase in blood is observed, comparable to that of essential amino acids, as regards tyrosine, histidine, asparagine, arginine, glycine, glutamine; a late increase for alanine, proline, citrulline.

As evidence of the effect of the biscuit on the bioavailability and on the elevation of the blood values of the administered amino acids, the aminoacidogram relative to other 18 amino acids dosed, normally present in the blood, but not administered with the biscuit, did not show any significant modification.

It is evident that, advantageously, the amino acid content according to the present invention allows effective nutritional effects (both therapeutic and preventive) to be obtained, without incurring the typical side effects of protein intake. For example, a quantity of 8 grams of amino acids in 100 grams of total mix is equivalent to a share of 50 grams of absorbed net proteins (for example 4 biscuits), but without a corresponding nitrogenous load, contraindicated in the elderly.

Moreover, advantageously, the amino acid composition comprising essential and non-essential amino acids, each with different trophic action on organs and tissues, allows to cover a wide range of pathologies and nutritional needs, in each age group, and in any condition, acute or chronic.

Furthermore, advantageously, the variety of mixes according to the present invention covers most of the products based on flour present in the food, such as pastes, biscuits, bitosted, up to the pastry, with and without gluten, ensuring a coverage of all the possibilities and daily feeding needs. Moreover, the intake of amino acids in daily diet allows the drug-nutritional properties of amino acids to be developed to the maximum and without any commitment for the subject.

With the present invention, it is possible to reintegrate for a suitable period and in a non-medicalized way the quantity of amino acids necessary to obtain a desired nutritional effect, counteracting the negative effects of the deficiency.

Moreover, the present invention, used on a large scale, allows to prevent amino acid deficiencies on a large number of subjects, bringing both social and economic benefits, considering the many chronic and acute pathologies that would benefit from an adequate amino acid intake and the consequent reduction of social networks costs linked to assistance for these diseases.

To date, there is no commercially available mix in the form of sachets or tablets, capable of administering a wide variety of amino acids, for example as many as 23, variously combined and assembled so as to meet the needs of a person at nutritional risk in any age of life, both for an increased need (childhood, adolescence, pregnancy, adulthood) in particular conditions of biological or health stress, or advanced age for a para-physiological decay of nutrient absorption capacities, for a pathologically reduced intake (aging anorexia, acute and chronic diseases, acute and chronic defeating diseases, neoplasms). To administer a mix similar in variety and quantity, infusions of parenteral infusion mixtures should be used.

Moreover, advantageously, the possibility of introducing large quantities of amino acids per 100 gr of product is another feature of the originality of the mix, both for bakery products and for bread products. The amino acid requirements in fact, if considered for each single amino acid, are rather high both in health and in disease, with variable needs both in the various ages of life and in various physiological conditions (childhood, adolescence, pregnancy, adulthood, maturity, first and second senescence) and pathological conditions (organ failure, neoplasms, acute critical illnesses both extemporaneous and recurrent, increases in requirements for any reason).

Further, advantageously, the simultaneous presence of essential amino acids and non-essential amino acids, and in particular of non-essential conditional amino acids, allow to obtain a strategic food for health in conditions of metabolic stress or increased demands. The nutritional complexity of the mix therefore gives it a unique and original versatility of use.

It is clear that a man skilled in the art may make changes to the invention described above in order to meet incidental needs, all falling within the scope of protection defined in the following claims.

1-22. (canceled)

23. Mix, suitable for the production of a gastronomic compound foodstuff, comprising a cereal flour, at least one essential amino acid and at least one non-essential amino acid or a conditionally essential amino acid.

24. Mix according to claim 23, wherein the essential amino acid is an amino acid added to the mix in isolated form.

25. Mix according to claim 23, wherein the at least one essential amino acid is selected from the group comprising L-leucine, L-lysine, L-isoleucine, L-valine, L-threonine, L-cysteine, L-histidine, L-phenylalanine, L-methionine, L-tyrosine, L-tryptophan.

26. Mix according to claim 23, also comprising thiamine or pyridoxine.

27. Mix according to claim 23, comprising at least 4% by weight of essential amino acids.

28. Mix according to claim 27, comprising at least 8% by weight of essential amino acids.

29. Mix according to claim 23, comprising between 0.1% and 15% inclusive by weight respectively of L-threonine and/or L-cysteine and/or L-histidine and/or L-phenylalanine and/or L-methionine and/or L-tyrosine and/or L-tryptophan.

30. Mix according to claim 23, comprising L-leucine, L-lysine, L-isoleucine, L-valine, L-threonine, L-histidine, L-phenylalanine, L-methionine, L-tyrosine, L-tryptophan.

31. Mix according to claim 23, comprising at least one non-essential amino acid selected from the group comprising alanine, aspartic acid, asparagine, glutamic acid, or at least one essential or conditionally essential amino acid selected from the group comprising threonine, arginine, citrulline, ornithine, cysteine, glutamine, glycine, serine, proline, taurine and tyrosine.

32. Mix according to claim 23, comprising a percentage by weight of amino acids less than or equal to 15% relative to the total weight of the mixture.

33. Mix according to claim 23 comprising dietary fibers in a percentage between or equal to 2% and 15% by weight relative to the total weight of the mix.

34. Mix according to claim 23 comprising dietary fibers in a percentage between or equal to 4% and 15% by weight relative to the total weight of the mix.

35. Mix according to claim 23, comprising food flavorings in an amount of at least 1 gram and up to 15 grams per kilogram of final mix.

36. Mix according to claim 23, comprising food flavorings in an amount of at least 3 gram and up to 9 grams inclusive per kilogram of final mix.

37. Mix according to claim 23, wherein the cereal flour is gluten-free.

38. Mix according to claim 23, comprising one or more of the following components: wheat flour, dietary fiber and wheat fiber, eggs, butter, granulated sugar, fructose and erythritol mixture, agave syrup, honey, sweeteners, maltitol, glucose syrup, malt extract, edible fats and oils, oil of various seeds, olive oil, extra virgin olive oil, palm oil, vanilla, dark chocolate, leavening agents.

39. Mix according to claim 23, comprising added medium-chain triglycerides.

40. Mix according to claim 23, comprising L-Leucine, L-Isoleucine, L-Valine, L-Lysine, L-Threonine, L-Histidine, L-Phenylalanine, L-Methionine, L-Tryptophan, Cysteine, Arginine, Citrulline, Ornithine, Glutamine, Glycine, Serine, Proline, Tyrosine, Taurine, Alanine, Asparagine, Aspartic acid, Glutamic acid.

41. Compound foodstuff, made using a mixture of ingredients comprising a mix according to claim 23.

42. A foodstuff according to claim 41, wherein said foodstuff is a pasta product or a bakery product, such as pasta or ravioli or gnocchi or bread or pizza or focaccia or cookies.

43. Compound foodstuff according to claim 42, said foodstuff being a cookie.

44. Method of preparation of a mix for the production of a gastronomic compound foodstuff, comprising the step of preparing a dry mixture of essential and non-essential amino acids with dietary and/or wheat fibers.

45. Method of preparation of a gastronomic compound foodstuff, comprising the method according to claim 44 and a cooking step of the mix, wherein the cooking temperature is between 145° C. and 190° C.

46. Method of preparation of a gastronomic compound foodstuff according to claim 45, wherein the cooking temperature is between 150° C. and 180° C.

47. Method of preparation of a gastronomic compound foodstuff according to claim 45, wherein the cooking temperature is equal to 180° C.

48. Use of a mixture of isolated essential and non-essential amino acids for the preparation of a mix intended for making a gastronomic foodstuff.
